(19) United States
(12) Patent Application Publication
(10) Pub. No.: US 2019/0212910 A1
(43) Pub. Date: Jul. 11, 2019

(54) METHOD FOR OPERATING A HUMAN-MACHINE INTERFACE AND HUMAN-MACHINE INTERFACE

(71) Applicant: BCS AUTOMOTIVE INTERFACE SOLUTIONS GMBH, Radolfzell (DE)

(72) Inventors: David Abt, Radolfzell (DE); Soeren Lemcke, Gundholzen (DE); Nikolaj Pomytkin, Konstanz (DE)

(21) Appl. No.: 16/238,627

(22) Filed: Jan. 3, 2019

(30) Foreign Application Priority Data
Jan. 5, 2018 (DE) 102018100197.5

(51) Int. Cl. G06F 3/0488; G06F 3/041; G06F 3/0482

(52) U.S. Cl. CPC G06F 3/04883; G06F 3/0418; B60K 37/06; G06F 2203/04808; G06F 2203/04104; G06F 3/0482

(57) ABSTRACT

A method for operating a human-machine interface (30) for a vehicle having a control unit (34) and at least one operating surface (32) which is constructed as a touch-sensitive surface comprises the following steps: (a) detecting a touch at at least one arbitrary touch point (46) of the at least one operating surface (32); b) detecting the quantity of touch points (46) on the at least one operating surface (32); c) detecting a gesture which is completed by the at least one touch point (46); and d) execution of a function by the control unit (34) depending on the detected gesture and the detected quantity of touch points (46). Further, a human-machine-interface (30) is shown.

### FIELD OF THE DISCLOSURE

The disclosure is directed to a method for operating a human-machine interface for a vehicle and to a human-machine interface for a vehicle.

### BACKGROUND

Human-machine interfaces for vehicles are known and, more and more commonly, have a touch-sensitive surface. However, the operation of touch-sensitive surfaces compared to the use of buttons requires greater attention on the part of the user. As a result, the user is distracted, particularly from traffic events.

For this reason, important functions or frequently used functions are each accessible through a separate button of a human-machine interface in the vehicle. However, since every function requires its own button, the space requirement increases.

### SUMMARY

Therefore, there is a need to provide a method for operating a human-machine interface and a human-machine interface which allow easy access to a multitude of functions and which also require less space.

The need is met by a method for operating a human-machine interface for a vehicle having a control unit and at least one operating surface which is constructed as a touch-sensitive surface, this method comprising the following steps:
a) detecting a touch at at least one arbitrary touch point of the at least one operating surface,
b) detecting the quantity of touch points on the at least one operating surface,
c) detecting a gesture which is completed by the at least one touch point, and
d) execution of a function by the control unit depending on the detected gesture and the detected quantity of touch points.

A very simple and intuitive access to many different functions is made possible in this way. A passenger of the vehicle will be familiar with the various gestures from commonly used devices, particularly smartphones. The amount of functions which can be executed by performing a gesture is multiplied through the detection of the quantity of touch points. Different functions can be achieved via the same operating surface so that the space requirement is minimal.

The function is a control function for a vehicle component such as the control of a media output, navigation system or telephone. For example, the current music playback can be paused, the volume changed or the navigation aborted by the function.

The control unit preferably determines whether or not the at least one touch point and how many of the at least one touch points correspond to a touch with a finger, and only those touch points which correspond to a touch with a finger are taken into account. Accordingly, unintentional touches on the operating surface, e.g., by the heel of the hand, are ignored so as to further facilitate operation of the human-machine interface. Touching with a stylus or like auxiliary devices can be equated to a touch with a finger.

For example, a touch is detected at one or more arbitrary touch points of the at least one operating surface, the gesture is completed with all of the touch points, and the completed gesture is taken into account if it was completed with all of the touch points. In particular, the gesture is only taken into account when it is completed with all of the touch points. This effectively prevents operating errors.

In one embodiment of the disclosure, the control unit is adapted to detect different gestures, with different functions being associated with different gestures, so that the quantity of quickly accessible functions is further expanded. The different gestures which can be detected by the control unit are also referred to as available gestures. In particular, a different function is associated with each gesture.

The functions which are associated with the various gestures preferably make up a function set, and the utilized function set is selected depending on the detected quantity of touch points on the at least one operating surface and/or the detected quantity of touch points which collectively complete the gesture. The operation of the human-machine interface can be further simplified in this way.

A function set contains a plurality of functions, in particular as many functions as the quantity of gestures that can be detected by the control unit.

The function sets can be associated in particular with various vehicle components, e.g., one function set is provided for operating the navigation system, while another function set is provided for operating the telephone.

In one embodiment of the disclosure, it can be detected which finger or which fingers is or are used on the operating surface, and the function and/or function set is selected depending on the finger or fingers being used so that the functions which can be executed by an individual gesture are expanded even further.

For example, the hand with which the operating surface is operated is detected, and the function and/or function set is selected depending on which hand is used. The amount of quickly accessible functions can also be expanded in this way.

Further, it can be determined whether the operating surface is being used by the right hand or left hand in order, for example, to establish whether it is the driver or the front seat passenger who is operating the operating surface.

Preferably, a gesture is completed through a movement of the at least one touch point in a predetermined direction and/or a gesture is completed through a movement of the at least one touch point in a first predetermined direction and subsequently in a second predetermined direction so that a simple but definitive detection of gestures is possible. For example, the first predetermined direction and second predetermined direction are opposed or are perpendicular to one another.

In one embodiment form, the predetermined direction is predetermined relative to the operating surface.

Alternatively or additionally, the control unit determines the position of the hand of a user based on the position of the touch points relative to one another, the predetermined direction being predetermined relative to the position of the hand.

In order to provide a large number of gestures, a gesture can be completed in that the touch point or the finger generating the touch point is removed briefly and placed again on substantially the same location.

For example, further gestures are conceivable by repeated removal and replacement. Also, different gestures may be distinguished through the time elapsed before renewed placement.

In a further embodiment of the disclosure, the function and/or function set is shown on an output screen spatially separate from the operating surface so as to distract the user as little as possible.

For example, the output can be effected together with the available gestures as soon as it has been detected that at least one arbitrary touch point on the at least one operating surface has been touched and/or as soon as the quantity of touch points touching the at least one operating surface has been detected.

The need is further met by a human-machine interface for a vehicle with at least one operating surface which is constructed as a touch-sensitive surface and with a control unit which is adapted to implement the method according to the disclosure, the at least one operating surface being connected to the control unit for data transfer.

The human-machine interface preferably has an output screen which is arranged spatially separate from the operating surface and/or from a vehicle component at which the operating surface is provided. The function which is executed by the control unit depending on the detected gesture and the detected quantity of touch points, the available gestures and/or the function set is displayed on the output screen. Operation of the human machine-interface is further facilitated in this way.

In one embodiment, the human-machine interface has at least one vehicle component, the operating surface is arranged at the at least one vehicle component, in particular a plurality of vehicle components are provided, and a plurality of operating surfaces are arranged at different vehicle components. Accordingly, it is always easy for the user to reach the operating surface.

The plurality of operating surfaces can be provided on different sides of a seat, in particular the driver's seat.

The plurality of operating surfaces preferably have the same functionality.

For example, the operating surface extends over at least 50%, particularly at least 75% of the surface of the respective vehicle component.

The operating surface can be arranged beneath a decorative surface of the vehicle component so that the decorative surface becomes a touch-sensitive surface.

Alternatively or additionally, the operating surface and/or the vehicle component can have a mechanical feedback element for haptic feedback, particularly a vibration motor, a pressure resistance and/or an ultrasound source.

For example, the vehicle component is a steering wheel, a seat, a control stick, a door panel, an armrest, a part of a center console, a part of a dashboard and/or a part of a headliner to allow a simple actuation of the operator control panel.

### DESCRIPTION OF THE DRAWINGS

Further features and advantages of the disclosure are apparent from the following description and the accompanying drawings to which reference is made and in which:

FIG. 1a) shows a perspective view of a cockpit of a vehicle which is provided with a human-machine interface according to the disclosure;

FIG. 1b) shows a schematic sectional view of part of the cockpit according to FIG. 1a) in the region of an operating surface of the human-machine interface;

FIGS. 2a) to 2c), 3a) to 3c) and 4a) to 4c) show illustrations of the method according to the disclosure.

### DETAILED DESCRIPTION

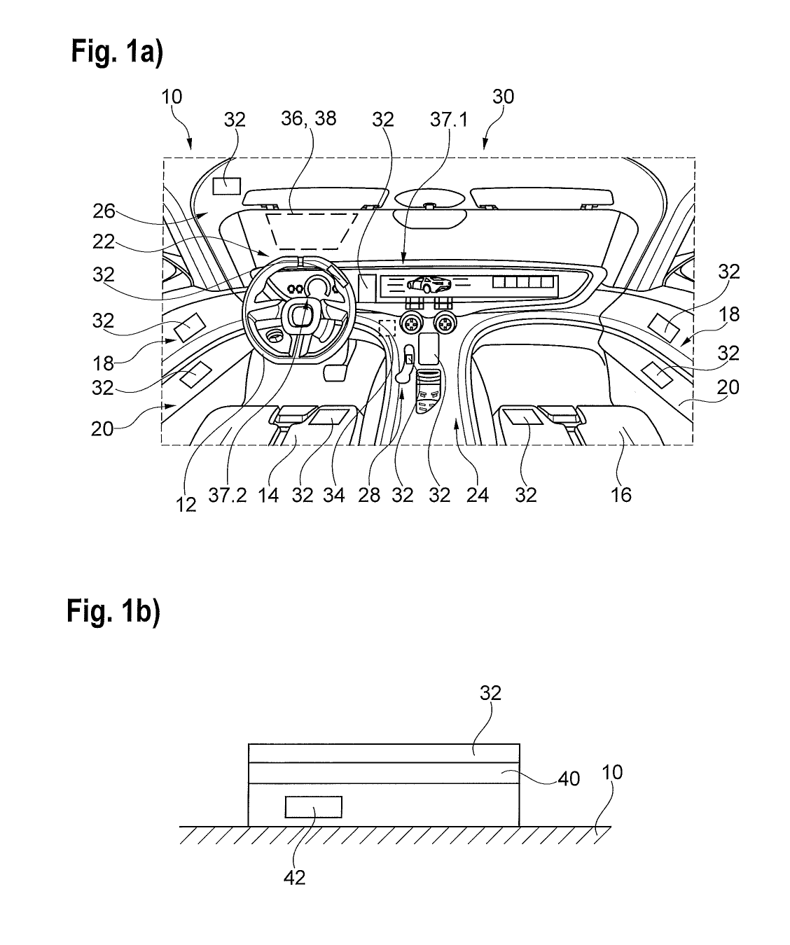

A cockpit of a vehicle is shown in FIG. 1a).

As is conventional, the cockpit has various vehicle components 10 such as a steering wheel 12, a driver's seat 14, a front passenger seat 16, door panels 18, armrests 20, a dashboard 22, a center console 24 and headliners 26.

Further, a control stick 28 can be provided in the cockpit.

In addition, the cockpit has a human-machine interface 30. In the present example, this human-machine interface 30 comprises a plurality of operating surfaces 32 which are formed as touch-sensitive surfaces, at least one control unit 34 and a plurality of output screens 36.

The control unit 34 is connected to the output screens 36 and the operating surfaces 32 for transferring data. This can take place via a cable or wirelessly.

In FIG. 1a), two screens 37.1, 37.2 are provided in the dashboard 22 as output screens 36, and a screen of a head up display 38 (HUD) likewise serves as output screen 36.

In the depicted embodiment example, the human-machine interface 30 has eleven operating surfaces 32 at various vehicle components 10. The vehicle components 10 at which the operating surfaces 32 are provided are then part of the human-machine interface 30.

However, it will be appreciated that the quantity of operating surfaces 32 is merely exemplary. The human-machine interface 30 can likewise be formed with only one operating surface 32 at one of the vehicle components 10 or with any other quantity of operating surfaces 32.

In the depicted embodiment, operating surfaces 32 are located, respectively, at each one of the door panels 18 of the driver's door and front passenger's door and at associated armrests 20.

An operating surface 32 is likewise arranged at the headliner 26 in the driver's area.

A further operating surface 32 is provided at the steering wheel 12. The operating surface 32 is shown on the front side of the steering wheel 12 in FIG. 1a). It is also possible and advantageous that the operating surface 32 extends to the rear side of the steering wheel 12 or is only formed at the latter.

Further, an operating surface 32 is provided in the dashboard 22 and an operating surface 32 is provided in the center console 24.

Operating surfaces 32 are also located at the driver's seat 14 and at the front passenger's seat 16 and serve in particular for seat adjustment. For purposes of illustration, these operating surfaces are shown on the upper sides of the seats 14, 16. However, they can also be located on the sides of the seats 14, 16 at the familiar positions for adjusting mechanisms for seats.

At least one operating surface 32 is also provided at the control stick 28. For example, the operating surface 32 at the control stick 28 is divided into different areas which are provided at the places on the control stick 28 that are contacted by a user's fingertips.

For purposes of illustration, the herein-described operating surfaces 32 are shown sharply limited spatially. It will be appreciated that the operating surfaces 32 can also be considerably larger and may occupy, for example, at least 50%, in particular at least 75% of the surface of the respective vehicle component 10. This takes into account only the surface of the respective vehicle component 10 facing the interior.

The operating surface 32 can be provided, for example, on top of or beneath a decorative surface of the respective vehicle component 10 so that large operating surfaces 32 can be realized in an optically suitable manner. The operating surface 32 can comprise a touch-sensitive foil.

It will be appreciated that at least one of the operating surfaces 32 can be formed together with one of the output screens 36 as a touch display.

In FIG. 1b), an operating surface 32 is shown in section at a vehicle component 10 by way of example.

In the depicted embodiment example, operating surface 32 is not directly fastened to vehicle component 10; rather, an optical element 40, in this case a further screen, is provided beneath the operating surface. However, the optical element 40 can also be an LED array or individual LEDs.

The screen and the operating surface 32 together form a touch-sensitive touch display such as is known, for example, in smartphones or tablets. Of course, it is also conceivable to switch the order of the operating surface 32 and optical element 40 and/or to provide another protective layer on the outer side.

Further, a mechanical feedback element 42 is provided between the operating surface 32 and vehicle component 10. In the depicted embodiment, this is a vibration motor which can vibrate the operating surface 32.

It is conceivable that the mechanical feedback element 42 is a pressure resistance such as is known from push keys (e.g., on a keyboard). The pressure resistance can generate a defined pressure point through a mechanical counterforce in order to give haptic feedback when pressing on the operating surface 32.

However, it is also conceivable that the mechanical feedback element 42 is an ultrasound source which emits ultrasonic waves in direction of a user's finger in order to give haptic feedback when actuating the operating surface 32.

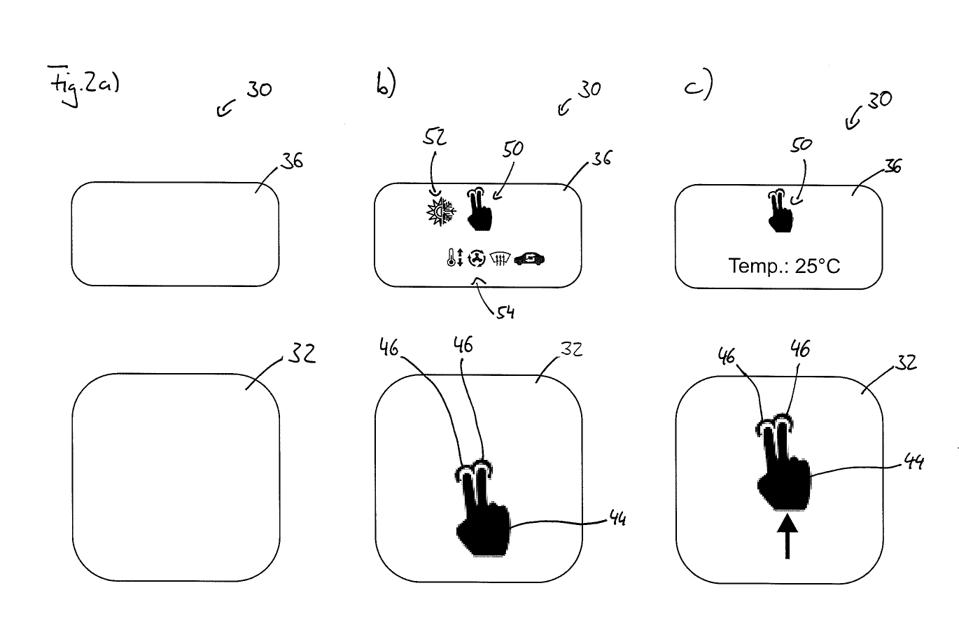

In FIGS. 2a) to 2c), 3a) to 3c) and 4a) to 4c), one of the operating surfaces 32 (bottom) and part of the display of an output screen 36 (top) are shown schematically to illustrate the method for operating the human-machine interface 30.

In the situation shown in FIGS. 2a) to 2c), the operating surface 32 is initially not touched and there is also no information displayed on output screen 36 (FIG. 2a).

When a user places two fingers of his hand 44 on the operating surface 32 as is shown in FIG. 2b), he touches the operating surface 32 with both fingers simultaneously so that two different touch points 46 are generated.

The user can place his hand anywhere on the operating surface 32 or his fingers can touch the operating surface 32 anywhere without disturbing the process.

The control unit 34 detects the touch of the fingers on the operating surface 32 or the touch points 46, and the control unit 34 also determines the quantity of touch points 46.

In so doing, the control unit 34 only takes into account touches or touch points 46 produced by the touch of a finger. Detection of whether or not a touch point 46 has been generated by a finger can be carried out, for example, through an analysis of the position of the touch points 46 relative to one another because the relative position of touch points 46 is predefined by human anatomy.

The size of the touch point 46 can also be determinative. In this way, for example, touching of the operating surface 32 by the heel of the hand 44 can be detected and ignored.

Accordingly, the control unit 34 can also detect which finger has generated the touch points 46.

It is also conceivable that the control unit 34 detects whether the operating surface 32 is operated by a left hand or a right hand.

When the control unit 34 has detected the quantity of touch points 36, i.e., two touch points 36 in the present instance, it selects a function set which is associated with the quantity of touch points 46 and which is stored, for example, in a storage of the control unit 34.

A function set includes a plurality of functions to which a gesture is associated in each instance, the corresponding function being executable by means of this gesture.

Within the disclosure of the disclosure, a gesture comprises a movement of the touch points 46 in a predetermined direction relative to the operating surface 32 or relative to the orientation of the user's hand 44. A gesture may also include complex movements with changes of direction such as zigzag movements, circular movements, or the like.

Within the disclosure of the present disclosure, however, a gesture also includes movements in which one of the touch points 46 is absent for a certain duration, for example, because the corresponding finger was lifted from the operating surface 32 for this duration and was subsequently placed again on essentially the same location from which it was removed.

The frequency with which a particular touch point 46 is removed and recurs through renewed placement, or the time elapsed before the renewed placement of the finger on the operating surface 32, can be part of the gesture and can accordingly be utilized to distinguish between various gestures.

For example, the following gestures can be distinguished: tap, double tap, tap and hold, drag, swipe, circle, and shuffle.

For tapping, the at least one corresponding finger is removed from the operating surface 32 and then taps again briefly on the operating surface 32. For double tapping, the finger taps on the operating surface 32 two times in quick succession. Accordingly, the at least one touch point 46 occurs again for a short period of time and can be detected by the control unit 36.

For tap and hold, the finger is left on the operating surface 32 after tapping. The gesture is then detected as completely done when the finger is kept on the operating surface 32 for a predetermined period of time after tapping.

For dragging, the at least one finger and therefore the at least one corresponding touch point 46 is moved over the operating surface 32 and is held in contact with the operating surface 32 after the movement.

Swiping is similar to dragging. In this case, the finger is lifted from the operating surface 32 at the end of the movement.

For the circling gesture, the at least one finger and therefore the at least one corresponding touch point 46 is moved in a circle over the operating surface. The gesture can be detected after only a certain portion of the circle has been covered, for example, a semicircle. Circular movements in clockwise direction and circular movements in counterclockwise direction can be different gestures.

For the shuffle gesture, the at least one finger and therefore the at least one corresponding touch point 46 is moved in a first predetermined direction and then in a second predetermined direction which, in particular, is opposed to the first direction.

It will be appreciated that the gestures mentioned above are merely illustrative. Further gestures with more complex movement sequences, for example, in the shape of an “L”, are conceivable.

The predetermined directions are defined in relation to the orientation of the operating surface 32 or in relation to the orientation of the user's hand 44. The orientation of the user's hand 44 can be detected by the control unit 34.

The functions within a function set are preferably thematically similar or affect the same components of the vehicle.

For example, the functions “increase target temperature”, “reduce target temperature”, “increase fan speed”, “reduce fan speed”, “defrost” and “recirculate air” are functions of the “air conditioning” function set which is used to control the air conditioning.

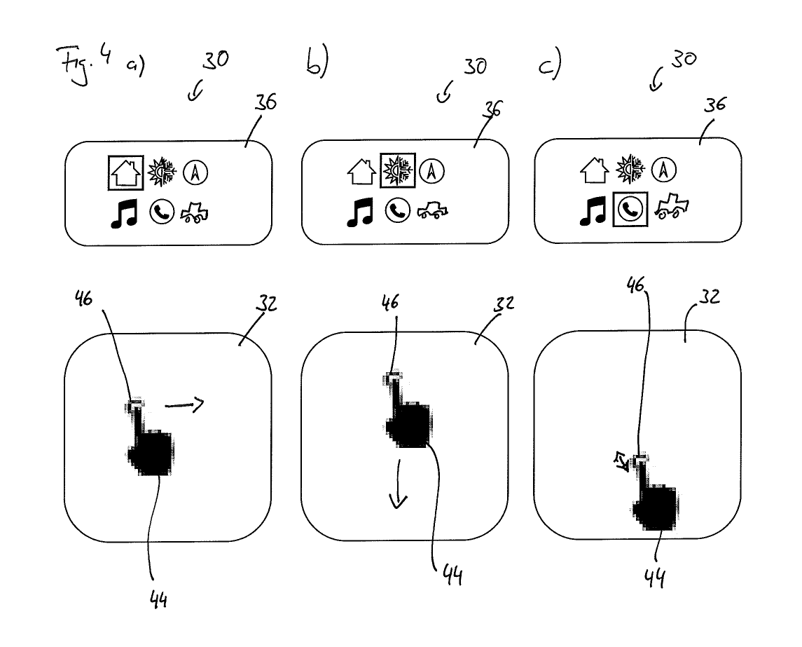

Other function sets are, for example, “navigation”, “entertainment”, “telephone” and “car settings” (compare FIG. 4).

In the depicted embodiment, touching the operating surface 32 at two touch points 46 is associated with the “air conditioning” function set which is correspondingly selected by the control unit 34.

The control unit 34 then displays on the output screen 36 the quantity of detected touch points 46, in this case by a corresponding hand icon 50, and the selected function set, in this case by a corresponding symbol 52.

Further, the functions are displayed by the control unit 34 through function symbols 54 provided in the selected “air conditioning” function set. The user can execute or access these functions through gestures with two fingers, i.e., gestures with two touch points 46.

In the depicted embodiment, the user wishes to increase the target temperature of the air conditioning. The gesture “drag upward” is assigned to this “increase target temperature” function. For the sake of simplicity, directions as stated herein refer to the drawing plane.

Accordingly, the user executes the corresponding gesture that is illustrated in FIG. 2c).

In the situation shown in FIG. 2, the user moves his two fingers upward so that the two touch points 46 likewise complete an upward movement relative to the user's hand.

Control unit 34 registers the movement and the trajectory of the touch points 46 and, in this way, determines the gesture that has been carried out. Accordingly, in this instance the control unit 34 detects the “drag upward” gesture in which the touch points 46 were moved essentially in a straight line in the predetermined direction (upward).

A gesture is only taken into account by the control unit 34 when it has been completely executed with all of the previously detected touch points 46. Only in this case will the corresponding associated function be executed by the control unit 34.

The “increase target temperature” function is associated with this gesture and the control unit 34 increases the target temperature of the air conditioning system.

At the same time, the control unit 34 displays the currently selected target temperature on the output screen 36 and changes this target temperature when the gesture is carried out.

The magnitude of the change in the target temperature can be determined, for example, based on the distance covered by the touch points 46. Alternatively or additionally, the magnitude may be determined by the velocity or the acceleration of the touch points 46 while the gesture is being executed.

When the desired target temperature is set, the user removes his hand from the operating surface 32, and the touch points 46 are accordingly canceled.

The interaction with the human-machine interface 30 is then concluded and, at this point at the latest, the control unit 34 stores the input of the user or transmits it to the corresponding vehicle components.

However, it is also conceivable that the user executes a further gesture, for example, moving his finger downward, immediately thereafter. Reducing the target temperature of the air conditioning is the function associated with this gesture, namely “drag downward”. Depending on the movement, the control unit 34 adjusts the target temperature and displays the value via the output screen 36.

Accordingly, the user has the illusion of moving a slide control for the target temperature with the two fingers.

Other functions such as “increase fan speed” and “reduce fan speed” are associated, for example, with a movement in transverse direction relative to the hand 44, i.e., “drag right” or “drag left” gestures.

It is also conceivable that the “defrost” and “recirculate air” functions are achieved, respectively, by the “clockwise circular movement” and “counterclockwise circular movement” gestures.

Accordingly, the user can execute a particular function very specifically through an individual gesture.

In the depicted embodiment, the function or function set was selected based on the quantity of touch points 46, i.e., the quantity of fingers used. Alternatively or additionally, the function or function set can be selected by the control unit 34 depending on which finger is used.

It will be appreciated that the control unit 34 can also select the function or function set depending on whether the left hand or the right hand operates the operating surface 32 so that different functions can be provided for the driver or for the front seat passenger.

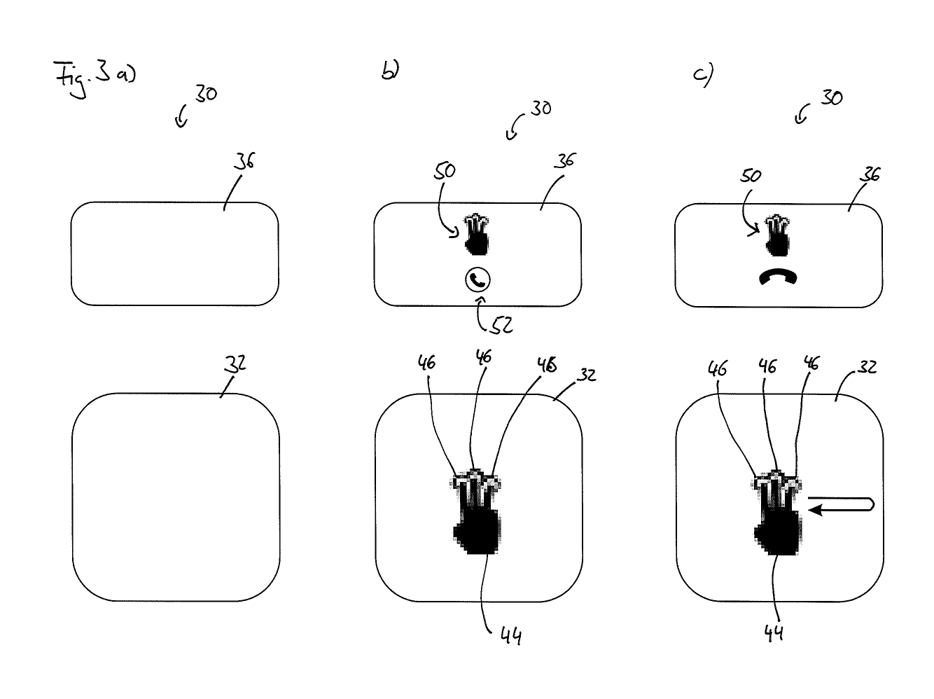

In the situation shown in FIGS. 3a) to 3c), the driver wishes to end the current telephone call by a gesture. At first, as is shown in FIG. 3a), there is no touch or touch point 46 on the operating surface 32. The “hang-up” function is assigned to the “shuffle” gesture when it is done with three touch points 46.

Accordingly, in order to hang up, the user touches the operating surface 32 at an arbitrary location (FIG. 3b) with three fingers of his hand 44 so that the “telephone” function set is selected. Subsequently, the user moves his three fingers on the operating surface 32 briefly to the right and then to the left again in the opposite direction relative to the hand 44.

The control unit 34 detects the “shuffle” gesture and executes the corresponding function associated with the gesture. In the present case, this ends the telephone call as per the user's wish.

Meanwhile, the user receives optical feedback via the output screen 36.

In the situation according to FIGS. 4a) to 4c), the gestures are used to navigate a menu displayed on the output screen 36.

In the situation shown in FIG. 4a), the user finds himself at a menu with which he can select different vehicle components. The vehicle components are represented by different symbols 56. The symbol for “main menu” in the situation shown in FIG. 4a) is highlighted by a cursor.

The user now wishes to access the “telephone” menu, and the movement of the cursor is achieved by gestures with one finger.

The user places a finger on the operating surface 32 and moves this finger to the right on the operating surface 32.

Accordingly, the user executes the “swipe right” gesture with one finger. The corresponding touch point 46 accordingly completes the corresponding gesture. The function associated with this gesture is the cursor being moved to the right for selecting a menu item.

The control unit 34 executes this function and, finally, the cursor lies on the symbol 56 for air conditioning as is shown in FIG. 4b.

The user then moves his finger downward so that the touch point 46 is also moved downward.

Touch point 46 accordingly completes a further gesture, namely, “swipe down”. A downward movement of the cursor is associated with this gesture.

Accordingly, the control unit 34 moves the cursor downward to the symbol for the “telephone” vehicle component.

The user now wishes to select this desired vehicle component and, to this end, briefly lifts his finger from the operating surface 32 and sets it down again at the same location.

The touch point 46 accordingly completes the “tap” gesture which is associated with the “select” function. Therefore, the control unit 34 selects the “telephone” vehicle component.

Alternatively or additionally, the “select” function can also be associated with other gestures, for example, a gesture like the “tap and hold” gesture which remains in one place for a longer period of time.

The situations shown in FIGS. 2 to 4 are not meant as separate embodiments. Rather, they merely show different situations during the utilization of the human-machine interface 30. However, these situations and functions are intended merely as examples.

For example, during the navigation shown in FIG. 4, the user can adjust the target temperature of the air conditioning with the “drag” gesture shown in FIG. 2 using two fingers and then continue navigation as is shown in FIG. 4. Accordingly, the gestures provide quick access to the functions.

1. Method for operating a human-machine interface for a vehicle having a control unit and at least one operating surface which is constructed as a touch-sensitive surface, comprising the following steps:
a) detecting a touch at at least one arbitrary touch point of the at least one operating surface,
b) detecting the quantity of touch points on the at least one operating surface,
c) detecting a gesture which is completed by the at least one touch point, and
d) execution of a function by the control unit depending on the detected gesture and the detected quantity of touch points.

2. Method according to claim 1, wherein the control unit determines whether or not the at least one touch point and how many of the at least one touch points correspond to a touch with a finger, wherein only those touch points which correspond to a touch with a finger are taken into account.

3. Method according to claim 1, wherein a touch is detected at one or more arbitrary touch points of the at least one operating surface, wherein the gesture is completed with all of the touch points, and the completed gesture is taken into account if it was completed with all of the touch points.

4. Method according to claim 1, wherein the control unit is adapted to detect different gestures, wherein different functions are associated with different gestures.

5. Method according to claim 1, wherein the functions which are associated with the various gestures make up a function set, wherein the utilized function set is selected depending on at least one of the detected quantity of touch points on the at least one operating surface and the detected quantity of touch points which collectively complete the gesture.

6. Method according to claim 1, wherein it is detected which finger or which fingers is/are used on the operating surface, wherein at least one of the function and function set is selected depending on the finger or fingers being used.

7. Method according to claim 1, wherein the hand with which the operating surface is operated is detected, wherein at least one of the function and function set is selected depending on the hand which is used.

8. Method according to claim 1, wherein at least one of a gesture is completed through a movement of the at least one touch point in a predetermined direction and a gesture is completed through a movement of the at least one touch point in a first predetermined direction and subsequently in a second predetermined direction.

9. Method according to claim 8, wherein at least one of the predetermined direction is predetermined relative to the operating surface.

10. Method according to claim 8, wherein the control unit determines the position of the hand of a user based on the position of the touch points relative to one another, and the predetermined direction is predetermined relative to the position of the hand.

11. Method according to claim 1, wherein a gesture is completed in that the touch point is removed briefly and placed again on substantially the same location.

12. Method according to claim 1, wherein at least one of the function and function set is shown on an output screen spatially separate from the operating surface.

13. Human-machine interface for a vehicle with at least one operating surface which is constructed as a touch-sensitive surface and with a control unit, wherein the at least one operating surface is connected to the control unit for data transfer, and wherein the control unit is adapted to implement a method comprising the following steps:
a) detecting a touch at at least one arbitrary touch point of the at least one operating surface,
b) detecting the quantity of touch points on the at least one operating surface,
c) detecting a gesture which is completed by the at least one touch point, and
d) execution of a function by the control unit depending on the detected gesture and the detected quantity of touch points.

14. Human-machine interface according to claim 13, wherein the human-machine interface has an output screen which is arranged spatially separate from at least one of the operating surface and from a vehicle component at which the operating surface is provided, wherein at least one of the function which is executed by the control unit depending on the detected gesture and the detected quantity of touch points, the available gestures and the function set is displayed on the output screen.

15. Human-machine interface according to claim 13, wherein the human-machine interface comprises at least one vehicle component (10, 12, 14, 16, 18, 20, 22, 24, 26, 28), wherein the operating surface is arranged at the at least one vehicle component (10, 12, 14, 16, 18, 20, 22, 24, 26, 28), in particular wherein a plurality of vehicle components (10, 12, 14, 16, 18, 20, 22, 24, 26, 28) are provided, wherein a plurality of operating surfaces are arranged at different vehicle components (10, 12, 14, 16, 18, 20, 22, 24, 26, 28).

16. Human-machine interface according to claim 15, wherein the vehicle component is at least one of a steering wheel, a seat (14, 16), a control stick, a door panel, an armrest, a part of a center console, a part of a dashboard and a part of a headliner.
